(19) United States
(12) Patent Application Publication
(10) Pub. No.: US 2025/0349484 A1
(43) Pub. Date: Nov. 13, 2025

(54) Contact Arrangement for an Electrical Switching Device and Electrical Switching Device

(71) Applicant: TE Connectivity Solutions GmbH, Schaffhausen (CH)

(72) Inventor: Matthias KROEKER, Schaffhausen (CH)

(73) Assignee: TE Connectivity Solutions GmbH, Schaffhausen (CH)

(21) Appl. No.: 19/199,440

(22) Filed: May 6, 2025

(30) Foreign Application Priority Data
May 13, 2024 (DE) 102024113294.9

(51) Int. Cl. H01H 50/54

(52) U.S. Cl. CPC H01H 50/546

(57) ABSTRACT

A contact arrangement for an electrical switching device and an electrical switching device with such a contact arrangement. The contact arrangement comprises two fixed contacts and an electrically conductive contact bridge which can be moved along a switching direction. The two fixed contacts each have at least one first leg and one second leg, wherein the two fixed contacts are each connected to an outer surface of the second leg, which is located on an outer side of a projection volume spanned by the first leg and by the second leg and can be electrically contacted by at least one switching contact element of the contact bridge.

### CROSS-REFERENCE TO RELATED APPLICATION

This application claims the benefit of German Patent Application No. 102024113294.9 filed on May 13, 2024 in the German Patent Office, which is hereby incorporated by reference in its entirety.

### BACKGROUND OF THE INVENTION

The present disclosure relates to a contact arrangement for an electrical switching device, for example an electrical DC switching device, such as a high-voltage contactor or relay. Furthermore, the present disclosure relates to an electrical switching device with such a contact arrangement.

In many areas of technology, electrical circuits are opened and closed by means of switching devices (also referred to below as “switching elements”) for control purposes. In most cases, contact elements that belong together are separated from each other or brought into contact with each other by an actuation device. When closed, an electrical current can flow through the circuit and operate electrical devices and modules arranged in the circuit. Opening the circuit, in turn, interrupts the current flow, so that the operation of the circuit can be stopped if necessary.

In many applications, for example in the field of electric mobility, a short-circuit in the circuit can cause an excessively high current flow, which also forcibly flows through the contact elements of the switching element. This so-called short-circuit current usually continues to flow until an electrical fuse (e.g. a safety fuse) in the circuit responds. At least during the fuse's reaction time, the short-circuit current not only endangers the switching element and all the other components in the circuit, but also the area around the circuit. In particular, the internal resistance of traction batteries has been continuously reduced in recent applications in the field of electric mobility in order to achieve shorter charging times for the traction battery. However, this has the disadvantage that the current peaks of the short-circuit currents in circuits with such traction batteries are reaching ever higher values and can now be as high as 20 kA or even higher.

Due to the strong repulsion forces (also referred to in the following as “repulsive forces”) that arise in the event of a short-circuit at such currents, conventional switching devices experience an uncontrolled opening of the contact elements, as a result of which the contact elements can be damaged by strong arcing or the electrical switching element can explode or plasma can escape from the electrical switching device. To prevent this uncontrolled opening in the event of a short-circuit, high contact forces are required to counteract the repulsion forces. To generate the high contact forces, appropriately large actuating elements are necessary. Since the repulsion forces increase quadratically with the short-circuit currents, a simple enlargement of the actuating elements leads to a drastic increase in the space required for the electrical switching element, which is particularly disadvantageous in a vehicle due to the natural limitation of the space available.

### SUMMARY OF THE INVENTION

There is thus a need for electrical switching devices that can withstand a short-circuit current for as long as possible without endangering people or the environment, and that can be manufactured safely and reliably, but still cost-effectively.

This object is solved by the subject-matter of the independent claims. Advantageous embodiments are the subject-matter of the dependent claims.

According to a first aspect, a contact arrangement for an electrical switching device is provided. The contact arrangement comprises two fixed contacts that are spaced apart from each other along an arrangement direction, and an electrically conductive contact bridge that is movable along a switching direction and has electrically conductive switching contact elements for making contact with each of the two fixed contacts. The contact arrangement has at least a closed position and an open position, wherein, in the closed position, the switching contact elements of the contact bridge establish electrical contact with the respectively associated fixed contacts, and, in the open position, the switching contact elements of the contact bridge have a predefined contact distance, measured in the switching direction, to the respectively associated fixed contacts. The two fixed contacts respectively comprise at least a first leg and a second leg, wherein the two fixed contacts are respectively contactable by at least one of the switching contact elements of the contact bridge on an outer surface of the second leg, which lies on an outer side of a projection volume spanned by the first leg and the second leg.

In particular, the present disclosure is based on the inventive idea of designing the fixed contacts in such a way that, in the closed state of the contact arrangement, they form a loop with the contact bridge in which the contact bridge is shielded as far as possible from magnetic fields that arise due to current flow in the fixed contacts and that induce repulsive forces in the contact bridge. In particular, the second leg of the fixed contacts serves respectively as a spacer between the respective first leg and the contact bridge, so that repulsive forces (or repulsion forces) induced on the contact bridge by the current flow in the first leg are attenuated by the distance. Furthermore, the fixed contacts are designed so that the contact bridge is arranged outside the projection volume spanned by the fixed contacts in the closed position and in the open position, so that simple assembly of the contact arrangement can be ensured, and in particular an ordinary actuation device can be used to switch the contact arrangement. Likewise, this design facilitates impacting the arcs that occur between the contact elements of the individual contact points when the contact arrangement is opened, for example by blowout magnets mounted in the switching device, and it is possible to adjust the over-stroke of the contact bridge on the armature.

Due to the specific design of the fixed contacts, the contact arrangement can thus in particular attenuate the repulsion forces between the fixed contacts and the contact bridge in the event of a short-circuit, so that opening of the contact bridge can be at least delayed or even completely suppressed even at high short-circuit currents of up to 20 kA, while at the same time the assembly and operation of the contact arrangement is not complicated compared to conventional contact arrangements.

According to a second aspect, in the open position, the contact bridge is located outside the projection volume spanned by the first leg and the second leg. In this manner, the contact bridge can be prestressed by a spring element in the open position against the closing direction, and a potentially simplified design of the contact arrangement and the associated actuation element can be achieved, which facilitates assembly of the contact arrangement and the associated actuation element.

According to a third aspect, each of the two fixed contacts has at least one fixed contact element forming a contact pair with a respectively associated switching contact element of the contact bridge. Hereby, the at least one fixed contact element is located respectively at an end of the second leg, which is located opposite the first leg. In this manner, contact resistance between the fixed contact and the contact bridge may be reduced while maximizing the distance between the contact bridge and the first leg of the fixed contacts. Thus, the repulsion forces induced on the contact bridge by current flow in the first leg can be maximally attenuated.

In an optional implementation of the third aspect, in each of the contact pairs, the fixed contact element and the associated switching contact element are arranged offset with respect to one another at least along the arrangement direction. In this way, the current distribution in the contact points that arise between the fixed contact elements and the switching contact elements in the closed position can be controlled so that at least part of the current flow through the contact points, which occurs in a direction parallel to the switching direction of the contact bridge, takes place at a greater distance from the contact bridge. Thus, the magnetic field strength of a magnetic field that is created by the current flow through the contact points of the contact arrangement (parallel to the switching direction) is reduced by the newly created distance in the area of the contact bridge. Since such a magnetic field also generates repulsive forces in the contact bridge due to the Lorentz force (similar to the currents in the first legs of the fixed contacts), the repulsive forces acting on the contact bridge in the closed position can also be attenuated by the displacement of the associated fixed contact elements and switching contact elements relative to one another.

According to a fourth aspect, the second leg is respectively aligned parallel to a contact bridge longitudinal direction of the contact bridge, which extends parallel to the arrangement direction. In this manner, the first leg can be arranged at a maximum distance from the contact bridge and it can be avoided that a current flow in the second leg generates a magnetic field which induces repulsion forces in the contact bridge. Thus, the repulsion forces induced by current flow in the fixed contacts in the contact bridge can be further attenuated and opening of the contact bridge can be further delayed or even completely suppressed even at high short-circuit currents of up to 20 kA.

According to a fifth aspect, the first leg is respectively aligned parallel to the switching direction of the contact bridge. In this manner, a current flow within the fixed contact, which flows perpendicular to the contact bridge longitudinal direction of the contact bridge and thus induces repulsion forces in the contact bridge, can be directed as far away as possible from the contact bridge, so that the repulsion forces induced in the contact bridge are attenuated by the distance.

According to a sixth aspect, the first leg and the second leg are respectively plate-shaped, and the second leg is arranged on the first leg at a predefined angle. In particular, the second leg is preferably arranged perpendicular to the first leg, so that the first leg and the second leg form an “L” shape. In this way, a particularly simple design of the fixed contacts can be achieved, which allows for simple assembly of the contact arrangement.

According to a seventh aspect, the second leg has at least one leg section in which an electric current flowing through the second leg generates attractive forces in the contact bridge which push the contact bridge towards the two fixed contacts. In other words, the second leg of each of the fixed contacts is in particular designed in such a way that a current flow in the second leg generates a magnetic field which induces attractive forces in the contact bridge that counteract the repulsive forces generated by the current flow in the first leg. Accordingly, opening of the contact bridge may be further delayed or even completely suppressed even at high short-circuit currents of up to 20 kA.

According to an eighth aspect, the second leg is designed in a stepped manner. In particular, the second leg is preferably arranged perpendicular to the first leg, so that the first leg and the second leg together form part of a “G” shape. In this manner, a particularly simple structure of the fixed contacts can be achieved, which enables simple assembly of the contact arrangement.

According to a ninth aspect, in each of the two fixed contacts, the at least one leg section of the second leg is arranged parallel to the first leg, and an electric current, which flows through the at least one leg section parallel to the switching direction in the closed position, flows in the opposite direction to an electric current, which flows position through the first leg parallel to the switching direction in the closed. In other words, the current flowing through the at least one leg section parallel to the switching direction in the closed position is opposite to the current impressed through the first leg parallel to the switching direction in the closed position. In the closed position of the contact bridge, there is thus an anti-parallel current flow in the two leg sections. In this manner, the current flow in the second leg generates an attractive magnetic field, which counteracts the magnetic field generated in the first leg. In this manner, the repulsion forces acting on the contact bridge can at least be attenuated and an opening of the contact bridge can be further delayed or even completely suppressed even at high short-circuit currents of up to 20 kA.

According to a tenth aspect, in each of the two fixed contacts, a distance between the first leg and the contact bridge is greater than a distance between the at least one leg section of the second leg and the contact bridge. In this manner, the magnetic field generated by the current flow in the first leg, which exerts repulsive forces on the contact bridge, is shielded more effectively than the magnetic field generated by the current flow in the second leg, which exerts attractive forces on the contact bridge. Due to the greater spatial proximity of the second leg to the contact bridge compared to the first leg, the overall force acting on the contact bridge is therefore attractive in the closing direction, i.e. the contact bridge is pushed by the current flow in the fixed contacts in the direction of the closed position. This means that opening of the contact bridge can be further delayed or even completely suppressed, even at high short-circuit currents of up to 20 kA.

According to an eleventh aspect, in each of the two fixed contacts, a length of the at least one leg section of the second leg along the switching direction is at least half as large as a length of the first leg along the switching direction. Since the magnetic field generated in the at least one leg section of the second leg scales with the length of the at least one leg section, a length of the at least one leg section may advantageously amount to between 70% and 90% of the length of the first leg along the switching direction.

According to a twelfth aspect, in each of the two fixed contacts, the first leg has at least two current conducting elements respectively, which are separated from each other by an air gap and which are electrically connected to the second leg separately from one another. In this manner, the distances between the current conducting elements of the first leg and the contact bridge can be further increased, so that the repulsion forces induced on the contact bridge by current flow in the first leg are attenuated. Thus, opening of the contact bridge can be at least delayed or even completely suppressed even at high short-circuit currents of up to 20 kA.

According to a thirteenth aspect, the first leg of each of the two fixed contacts is respectively at least partially surrounded by a first flow guiding piece, which at least partially shields a magnetic field generated in the first leg by current flow in the direction of the contact bridge. In this manner, the repulsion forces induced on the contact bridge by current flow in the first leg can be attenuated. This means that opening of the contact bridge can be further delayed or even completely suppressed even at high short-circuit currents of up to 20 kA.

In an additional or alternative implementation of the thirteenth aspect, the contact arrangement further has at least one ferromagnetic flow guiding piece which, at least in the closed position, exerts an attractive force on the contact bridge. In this manner, the repulsion forces induced on the contact bridge by current flow in the fixed contacts can at least be attenuated. Thus, opening of the contact bridge can be further delayed or even completely suppressed even at high short-circuit currents of up to 20 kA.

According to a fourteenth aspect, in each of the second legs, a contact section, in which the associated switching contact elements of the contact bridge establish electrical contact with the second leg, is thinner than a connecting section, which connects the contact section to the associated first leg, wherein the thickness of the contact section and of the connecting section is measured respectively parallel to the switching direction. In this manner, in the contact section of the fixed contact, i.e. in an area of the fixed contact in which the fixed contact elements are arranged, the current flow that occurs parallel to the switching direction of the contact bridge can be spatially limited, so that such a current flow partially occurs further away from the contact bridge. In this manner, the magnetic field strength of a magnetic field that is created by such a current flow through the contact points of the contact arrangement (parallel to the switching direction) is reduced in the area of the contact bridge. Since such a magnetic field also generates repulsive forces in the contact bridge due to the Lorentz force (similar to the currents in the first legs of the fixed contacts), the repulsive forces generated by the current flow through the contact points in the contact bridge can thus also be attenuated. Thus, opening of the contact bridge can be further delayed or even completely suppressed, even at high short-circuit currents of up to 20 kA.

According to a fifteenth aspect, an electrical switching device is provided, which comprises the contact arrangement according to one of the above-mentioned aspects and an actuation device, which is designed to move the contact bridge of the contact arrangement between the closed position and the open position. In particular, the actuation device moves the contact bridge between the closed position and the open position respectively outside the projection volume spanned by the first leg and by the second leg. In this manner, the repulsion forces between the fixed contacts and the contact bridge in the event of a short-circuit can be attenuated, so that opening of the contact bridge, even at high short-circuit currents of up to 20 kA, can at least be delayed or even suppressed altogether, while at the same time the assembly and operation of the contact arrangement is not complicated in comparison to conventional contact arrangements. Likewise, this design improves impacting the arcs that occur between the contact elements of the individual contact points when the contact arrangement is opened, for example, by blowout magnets mounted in the switching device.

According to a sixteenth aspect, which may be implemented alone or in combination with one or more of the previous aspects, a contact arrangement for an electrical switching device is provided, wherein the contact arrangement comprises two fixed contacts that are spaced apart from each other along an arrangement direction, and an electrically conductive contact bridge that is movable along a switching direction and has electrically conductive switching contact elements for establishing contact with each of the two fixed contacts. The contact arrangement has at least a closed position and an open position, wherein, in the closed position, the switching contact elements of the contact bridge establish electrical contact with the respectively associated fixed contacts, and, in the open position, the switching contact elements of the contact bridge have a predefined contact distance, measured in the switching direction, to the respectively associated fixed contacts. In each of the fixed contacts, a contact section, in which the switching contact elements of the contact bridge establish electrical contact with the respectively associated fixed contact, is thinner than a section of the fixed contact that is adjacent to the contact section, wherein the thickness of the contact section and of the adjacent section is measured respectively parallel to the switching direction.

The sixteenth aspect is also based on the inventive idea described above and is intended to help design the fixed contacts so that, when the contact arrangement is in the closed state, they form a loop with the contact bridge, in which the contact bridge is shielded as far as possible from magnetic fields that arise due to current flow in the fixed contacts and that induce repulsive forces in the contact bridge. In particular, the current flow, which occurs parallel to the switching direction of the contact bridge, can be spatially limited to a maximum length by the specific design of the contact section of the fixed contact, that is, an area of the fixed contact in which the fixed contact elements are arranged. This reduces the magnetic field strength of a magnetic field that is created by such a current flow through the contact points of the contact arrangement (parallel to the switching direction) in the area of the contact bridge. Since such a magnetic field also generates repulsive forces in the contact bridge due to the Lorentz force (similar to the currents in the first legs of the fixed contacts), the repulsive forces generated by the current flow through the contact points in the contact bridge can thus also be attenuated. Thus, opening of the contact bridge can be further delayed or even suppressed altogether, even at high short-circuit currents of up to 20 kA.

According to a seventeenth aspect, which may be provided in particular in combination with the sixteenth aspect, each of the two fixed contacts has at least one fixed contact element forming a contact pair with a respectively associated switching contact element of the contact bridge, and in each of the contact pairs the fixed contact element and the respectively associated switching contact element are arranged offset with respect to one another at least along the arrangement direction. This also contributes in controlling the current distribution in the contact points, which arise between the fixed contact elements and the switching contact elements in the closed position, so that at least part of the current flow through the contact points, which occurs in a direction parallel to the switching direction of the contact bridge, takes place at a greater distance from the contact bridge. Thus, the magnetic field strength of a magnetic field that is created by the current flow through the contact points of the contact arrangement (parallel to the switching direction) is reduced by the newly created distance in the area of the contact bridge. This also attenuates the repulsion forces acting on the contact bridge in the closed position.

### BRIEF DESCRIPTION OF THE DRAWINGS

For a better understanding, the present invention is explained in more detail by means of the examples shown in the following figures. The same parts are provided with the same reference signs and the same component designations. Furthermore, some features or combinations of features from the different embodiments shown and described can also represent independent, inventive or inventive solutions. The following show:

FIG. 1 a schematic perspective view of a first exemplary contact arrangement;

FIG. 2 a schematic perspective view of a fixed contact of the first exemplary contact arrangement;

FIG. 3 a schematic side view of the first exemplary contact arrangement;

FIG. 4 a schematic diagram of a magnetic field strength generated in a fixed contact of the first exemplary contact arrangement;

FIG. 5 a schematic side view of an alternative design of the first exemplary contact arrangement;

FIG. 6 a schematic side view of a further alternative design of the first exemplary contact arrangement;

FIG. 7 a schematic side view of a further alternative design of the first exemplary contact arrangement;

FIG. 8 a schematic perspective view of a second exemplary contact arrangement;

FIG. 9 a schematic top view of the second exemplary contact arrangement;

FIG. 10 a schematic perspective view of a third exemplary contact arrangement;

FIG. 11 a further schematic perspective view of the third exemplary contact arrangement;

FIG. 12 a schematic perspective view of a fixed contact of the third exemplary contact arrangement;

FIG. 13 a schematic side view of the third exemplary contact arrangement;

FIG. 14 a schematic cross-sectional view of the third exemplary contact arrangement along the line of section XIV-XIV drawn in FIG. 13;

FIG. 15 a schematic cross-sectional view of the third exemplary contact arrangement along the line of section XV-XV drawn in FIG. 11;

FIG. 16 a further schematic cross-sectional view of the third exemplary contact arrangement along the line of section XV-XV drawn in FIG. 11;

FIG. 17 a schematic side view of a section of a fourth exemplary contact arrangement;

FIG. 18 an enlargement of the contact area between the fixed contact and the contact bridge shown in FIG. 17.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the preferred embodiments. Accordingly, the invention expressly should not be limited to such embodiments illustrating some possible non-limiting combination of features that may exist alone or in other combinations of features, the scope of the invention being defined by the claims appended hereto.

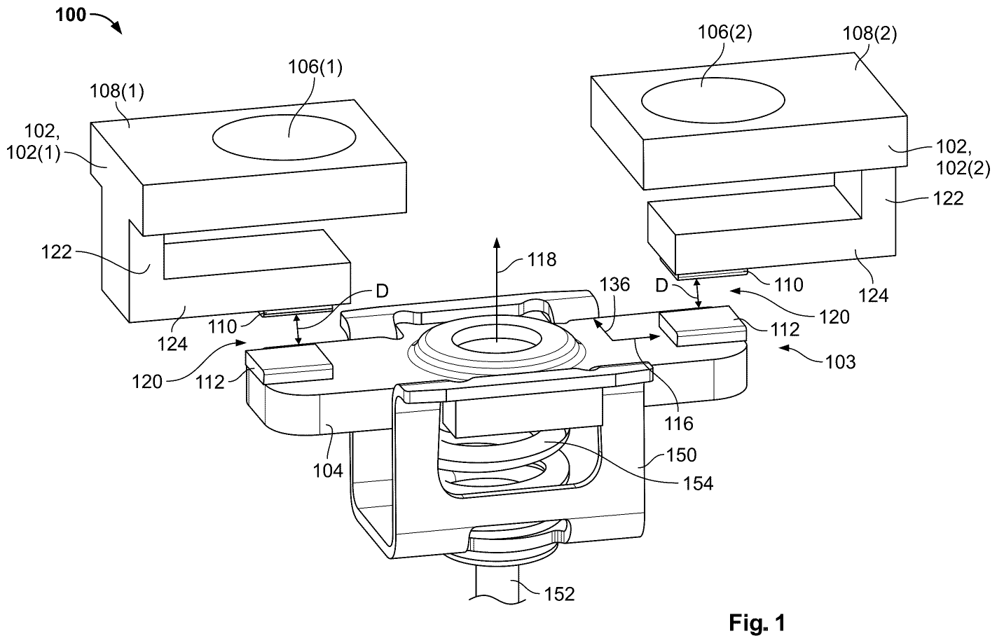

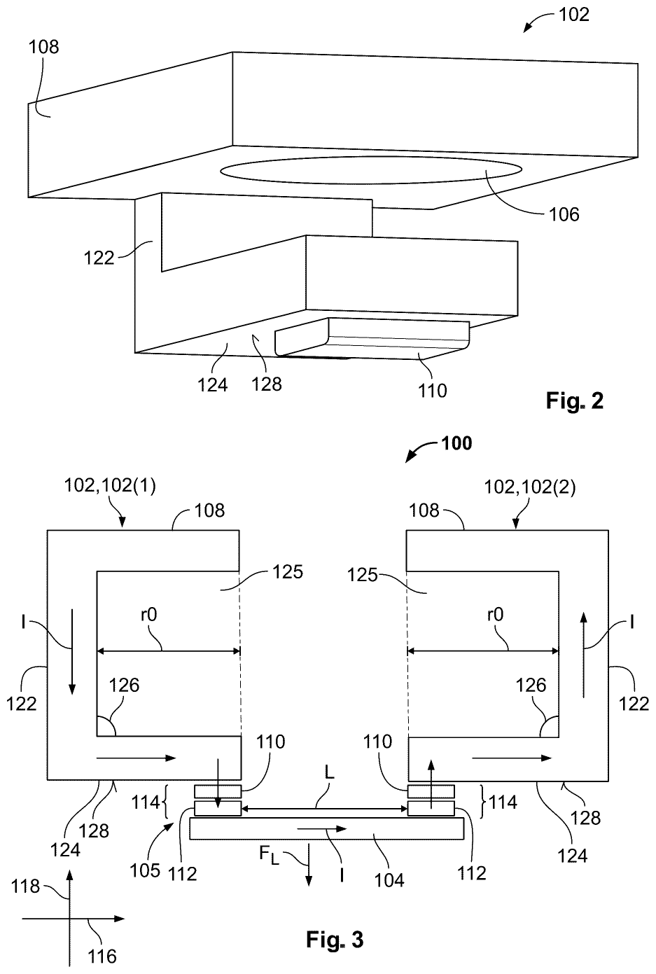

The present disclosure will be explained in more detail below with reference to the figures, and first with reference to the schematic perspective views of FIGS. 1 and 2. It should be noted that in all figures, the proportions and in particular the layer thicknesses are not necessarily shown to scale. Furthermore, parts that are not necessary for understanding or that hinder understanding are not shown, in particular electrically insulating housing elements and protective covers.

FIG. 1 shows a first exemplary contact arrangement 100, which can be part of a switching element. In particular, the contact arrangement 100 can be installed in a housing of the switching element and/or have its own housing, preferably made of electrically non-conductive material. Furthermore, an actuation device may be installed in the housing and may be connected to the contact arrangement 100 in a force-transmitting manner at least in part. The switching element may, for example, be an electrical DC switching element, such as a high-voltage contactor or relay. However, the present disclosure is not limited to DC and/or high-voltage applications and may also be used in other electrical switching devices.

The contact arrangement comprises two fixed contacts 102(1) and 102(2) and a contact bridge 104. The fixed contacts 102 each have the same shape, which is shown in more detail in FIG. 2. In order to install the switching element in an electrical circuit (not shown) to be controlled, the fixed contacts 102 each comprise terminal sections 106(1), 106(2) that are spaced apart from each other and arranged so as to be accessible from outside the housing. The terminal sections 106(1), 106(2) are designed on their respective outer sides to accommodate an electrical conductor (not shown) or a fixing element (not shown) of the electrical conductor.

Hereby, a respective terminal section 106(1), 106(2) is assigned to each of the two fixed contacts 102, which is respectively arranged on a base 108 of the respective fixed contact 102. The electrically conductive, stationary fixed contacts 102(1) and 102(2) of the contact arrangement 100 are each held stationary with respect to the housing and are spaced apart from each other, similar to the associated terminal sections 106(1), 106(2). The fixed contacts 102(1) and 102(2) also respectively have at least one electrically conductive fixed contact element 110, which can establish contact with an associated electrically conductive switching contact element 112 of the contact bridge 104. The fixed contact elements 110 and switching contact elements 112 can respectively be plate-shaped contact elements, while lens-shaped, dome-shaped or otherwise shaped contact elements are also possible. A fixed contact element 110 and the associated switching contact element 112 form a contact pair 114 and, when in contact, generate a contact point or a contact location (see FIG. 3). Depending on requirements, each of the fixed contacts 102 can have more than one fixed contact element 110, which can be contacted with an associated switching contact element 112 of the contact bridge 104, so that several contact pairs 114 can be provided between each of the fixed contacts 102 and the contact bridge 104.

The movable, electrically conductive contact bridge 104 extends between the fixed contact elements 110. The contact bridge 104 is preferably a rod-shaped or bar-shaped component which extends along a contact bridge longitudinal direction 116. The two fixed contacts 102(1), 102(2) and the terminal sections 106(1), 106(2) are spaced apart from each other in the contact bridge longitudinal direction 116.

The switching contact elements 112, which can establish contact with the fixed contact elements 110 of both fixed contacts 102(1), 102(2), are arranged on the contact bridge 104. In particular, the switching contact elements 112 can be welded, soldered, pressed, riveted or screwed to the contact bridge 104. Similarly, the fixed contact elements 110 can be welded, soldered, pressed or screwed to the fixed contacts 102(1), 102(2) respectively. Alternatively, the switching contact elements 112 may be an integral component of the contact bridge 104 or applied as a coating to the contact bridge 104. Similarly, the fixed contact elements 110 can also be an integral component of the respective fixed contact 102(1), 102(2) or applied as a coating to the respective fixed contact 102(1), 102(2). In order to reduce the contact resistance between the fixed contacts 102(1), 102(2) and the contact bridge 104, the fixed contact elements 110 and the switching contact elements 112 can be formed respectively in particular from silver or a silver alloy.

The contact bridge 104 has at least an open position 103 (see FIG. 1) and a closed position 105 (see FIG. 3). Between the open position 103 and the closed position 105, the contact bridge 26 is preferably movable linearly along a switching direction 118. An actuation device (not shown) may be used for this movement. In other words, the actuation device can be configured to move the contact bridge 104 between the closed position 105 and the open position 103. In particular, the actuation device can have an idle state in which the contact bridge 104 is in the open position 103 and an activated state in which the contact bridge 104 can be in the closed position 105.

As shown in FIG. 1, in the open position 103, the switching contact elements 112 of the contact bridge 104 are spaced apart from the respectively associated fixed contact elements 110 of the fixed contacts 102(1) and 102(2). In particular, in the open position 103, the switching contact elements 112 have a predefined contact distance D, measured in the switching direction 118, from the respectively associated fixed contact elements 110. Hereby, the switching contact elements 112 and the fixed contact elements 110 can be spaced apart in the open position 103 by an opening gap 120. This has the effect that no electric current can flow between the terminal sections 106(1) and 106(2) via the contact bridge 104, or rather that any current flowing up to that point is interrupted. The circuit is opened accordingly.

As shown in FIG. 3, in the closed position 105, the switching contact elements 112 of the contact bridge 104 establish electrical contact with the respectively associated fixed contact elements 110 of the fixed contacts 102(1) and 102(2). This closes the circuit so that the electric current can flow between the terminal sections 106(1) and 106(2) via the contact bridge 104. The closed position 105 represents the normal operation of the contact arrangement 100, in which an operational current I (indicated by the current arrows) flows through the terminal sections 106(1), 106(2), the fixed contacts 102(1), 102(2) and the contact bridge 104. While the contact arrangement in the described examples respectively has one contact bridge, alternatively there may be provided a plurality of (at least two) parallel contact bridges which are moved by means of a common actuation device, wherein each of the several contact bridges in the closed position 105 electrically connects the two fixed contacts 102(1) and 102(2). This can help to reduce the repulsion forces between the fixed contact elements 110 and the switching contact elements 112.

In order to minimize the repulsion forces on the contact bridge 104 in the closed position 105 in the event of a short-circuit, the fixed contacts 102 in the first embodiment each have a first leg 122 and a second leg 124, as shown in FIGS. 1 to 3. The first leg 122 extends downwards from the base 108 of the fixed contact, in respectively parallel to the switching direction 118 of the contact bridge 104. The second leg 124 respectively adjoins the first leg 122 and extends parallel to the contact bridge longitudinal direction 116, so that the second leg 124 serves as a spacer between the first leg 122 and the contact bridge 104. Hereby, the second leg 124 is arranged on the first leg 122, in particular, in such a way that the two legs form an “L-shape”. In particular, the first leg 122 and the second leg 124 form together with the base 108 of the fixed contact 102 a “C” shape in the side view (see FIGS. 5 to 7). A longitudinal direction of the second leg 124 thus includes in particular an opening angle 126 of approximately 90° with a longitudinal direction of the first leg 122, wherein, however, depending on the application other opening angles may be selected instead.

The fixed contact elements 110 are arranged respectively on an outer surface 128 of the fixed contacts 102(1) and 102(2), which are formed by an outer surface of the second leg 124, and which lies on an outer side of a projection volume 125 spanned by the first leg 122 and by the second leg 124 (see FIG. 3). The projection volume 125 spanned by the first leg 122 and the second leg 124 should be understood as the volume which is located within the fixed contacts 102(1) and 102(2), if the fixed contacts 102(1) and 102(2) were to be closed by an (imaginary) plate on its open side. In other words, the fixed contact elements 110 are arranged respectively on an outer surface of the second legs 124, which faces away from the base 108 and the associated terminal sections 106(1), 106(2). Thus, the contact surfaces of the fixed contact elements 110 point in the direction of the actuation device and the contact bridge 104 can be pressed onto the fixed contact elements 110 in the switching direction 118 by the actuation device from the outside, that is to say from outside the “C” shape spanned by the fixed contacts, to electrically connect the two fixed contacts 102(1) and 102(2) to one another. Hereby, the actuation device of the switching element moves the contact bridge 104 between the closed position 105 and the open position 103 respectively outside the projection volume 125 spanned by the first leg 122 and by the second leg 124.

This has the advantage that the contact bridge 104 can be pressed onto the fixed contacts 102 from the outside by the actuation device, so that the installation of a complicated actuation device can be avoided. In particular, the contact bridge 104 can be biased by a spring element (not shown) in the open position 103 against the closing direction, so that the spring element supports a rapid opening of the contact bridge 104 when the bridge is brought from the closed position 105 into the open position 103. Furthermore, the impact on the arcs by blowout magnets, which are provided in the switching element, is simplified.

The following discussion shall explain how the first exemplary contact arrangement 100 works when the contact bridge 104 is in the closed position 105. If, for example, the terminal section 106(1) is connected to the high-potential side of the circuit (for example to a positive connection terminal of a drive battery), the operational current I flows, as schematically illustrated in FIG. 3, from the terminal section 106(1) through the fixed contact 102(1) into the contact bridge 104, from which the operational current I flows through the fixed contact 102(2) into the terminal section 106(2), which may, for example, be connected to a load of the circuit. Contact arrangement 100 can, of course, also be connected in the opposite direction, so that the current flows in the opposite direction. Due to the symmetrical arrangement of fixed contacts 102(1) and 102(2) in relation to each other, this has no influence on the effects described below.

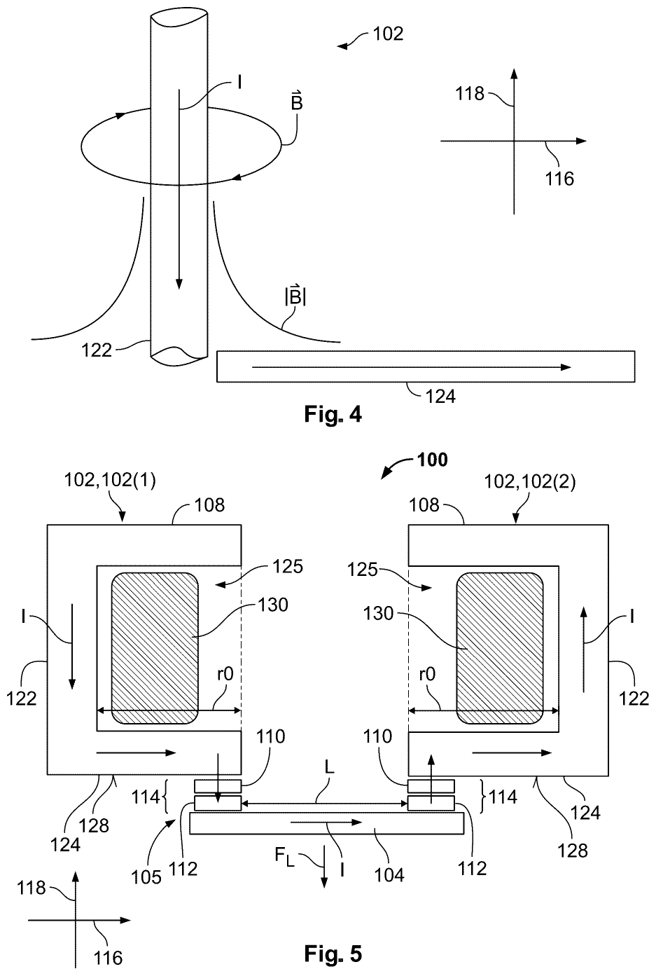

As shown in FIG. 3, due to the specific shape of fixed contact 102(1), in the first leg 122 of the fixed contact 102(1), the operational current flows along (or parallel to) the switching direction 118 of the contact bridge and in the opposite direction to the closing direction, i.e. in the opposite direction to the direction, in which the actuation device exerts a force on the contact bridge 104 in the closed position 105. As shown schematically in FIG. 4, the current flow in the first leg 122 of the fixed contact 102(1) generates a magnetic flux density B (also referred to below as “magnetic field B”), which surrounds the first leg 122 of the fixed contact 102(1) in a circle. Likewise, a magnetic field B is generated by the current flow in the first leg 122 of the fixed contact 102(2), which surrounds the first leg 122 of the fixed contact 102(2) in the opposite direction in a circle (not shown). The magnetic fields B generated in the first legs 122 of the fixed contacts 102(1) and 102(2) respectively exert a Lorentz force on current-carrying conductors that run horizontally to the first leg 122 of the fixed contact 102(1). Due to the alignment of the fixed contacts 102(1) and 102(2), the magnetic fields B generated in the first legs 122 of the two fixed contacts 102(1) and 102(2) therefore exert a Lorentz force FL (see FIG. 3) on the operational current I flowing in the contact bridge 104, which pushes the contact bridge 104 against the closing direction of the contact bridge 104. Thus, a repulsion force is induced on the contact bridge 104 by the current flow through the first legs 122 of the two fixed contacts 102(1) and 102(2), which acts in addition to the repulsion forces which arise between the fixed contact elements 110 and the switching contact elements 112 in each of the contact pairs 114 when current flows, and which push the contact bridge in the direction of the open position 103.

During normal operation of the switching element, that is to say at usual intensities of the operational current I in the range of below 5 kA, the repulsion forces induced can be counterbalanced by the actuation force which the actuation device exerts on the contact bridge 104, and the contact bridge 104 remains in the closed position 105. However, the magnetic fields B generated in the first legs 122 of the two fixed contacts 102(1) and 102(2) is linearly dependent on the current strength of the operational current I, so that the Lorentz force FL acting on the contact bridge 104 in the direction of the open position 103 scales with I². Thus, in the event of a short-circuit, in particular at currents above 5 kA, quickly repulsion forces may act on the contact bridge 104, which for known switching elements force the contact bridge 104 to open. In this case, the contact bridge 104 may open before a safe disconnection of the circuit by an overcurrent protection device, such as a fuse or a pyrotechnic fuse, is performed. As a result, the energy present in the circuit may be discharged in the arcs between the opened contact points of the known switching elements, whereby unwanted irreparable damage to the known switching elements quickly occurs.

The forced opening by the repulsion forces is shifted to higher currents in contact arrangement 100 due to the specific shape of the two fixed contacts 102(1) and 102(2). As internal inductances delay the rise of the current until the maximum short-circuit current is reached, increasing the levitation limit increases the window until an overcurrent protection device in the circuit connected to the contact arrangement 100 can safely trigger. As shown in FIG. 4, a magnetic field strength of the magnetic field B, caused by the current flow in the first legs 122 of the two fixed contacts 102(1) and 102(2) is dependent on the distance to the first leg 122. More precisely, the magnetic field strength of the magnetic field B is proportional to 1/R, wherein R denotes the distance between the measuring point and the first leg 122.

Thus, in the contact arrangement 100, the effect of the magnetic field B, generated in the first legs 122 of the two fixed contacts 102(1) and 102(2) by current flow, on the contact bridge 104 is attenuated by the distance r0, with which the first legs 122 are spaced apart from the contact bridge 104 by the second legs 124, along the contact bridge longitudinal direction 116. Hereby, a length r0 (see FIG. 3) of the second legs 124 along the contact bridge longitudinal direction 116 should be selected such that the repulsion forces acting on the contact bridge 104 are reduced sufficiently strongly to delay an opening of the contact arrangement 100, while at the same time certain lengths should not be exceeded, so as not to make the space requirement of the contact arrangement 100 too large. For example, depending on the application, the length r0 can be in the range of 10 mm to 25 mm in order to achieve the attenuation of the repulsion forces acting on the contact bridge 104 and to avoid an excessive increase in the size of a switching device having the contact arrangement 100.

In particular, the distance between the first legs 122 of the fixed contacts 102 and the contact bridge 104 can be increased if the fixed contact elements 110 are each arranged at one end of the second leg 124 of the fixed contacts 102, which is opposite to the respectively associated first leg 122 of the fixed contacts. In this way, the full length r0 of the second leg 124 can be utilized to increase the distance between the first legs 122 and the contact bridge 104.

Furthermore, a length L (see FIG. 3) of the contact bridge 104 along the contact bridge longitudinal direction 116 between the closing contact elements 112 can be selected to be as short as possible, in order to reduce the penetration area in which the magnetic field B, generated in the first legs 122 of the fixed contacts 102 by the current flow, penetrates the contact bridge 104. However, the length L of the contact bridge must be at least long enough for the fixed contact elements 110 of the two fixed contact elements 102(1) and 102(2) to be sufficiently electrically isolated from each other in the open position 103 to prevent flashover. The length L should therefore not be less than a lower limit of 15 mm-20 mm, for example.

In order to further attenuate the magnetic field B generated by the current flow in the first legs 122 of the fixed contacts 102, the contact arrangement 100 can have first ferromagnetic flow guiding pieces 130, as shown schematically in FIG. 5. Hereby, the first flow guiding pieces 130 can completely surround the first legs 122 of the two fixed contacts 102(1) and 102(2). In order to save material, the flow guiding pieces can also surround the first legs 122 of the two fixed contacts 102(1) and 102(2) only in the direction of the contact bridge 104, in order to attenuate the magnetic field B, which is generated by the current flow in the first legs 122, in the direction of the contact bridge 104. The first flow guiding pieces 130 should be made of a material with a high magnetic permeability, such as iron or an iron alloy, in order to maximize the shielding of the magnetic field B in the direction of the contact bridge 104.

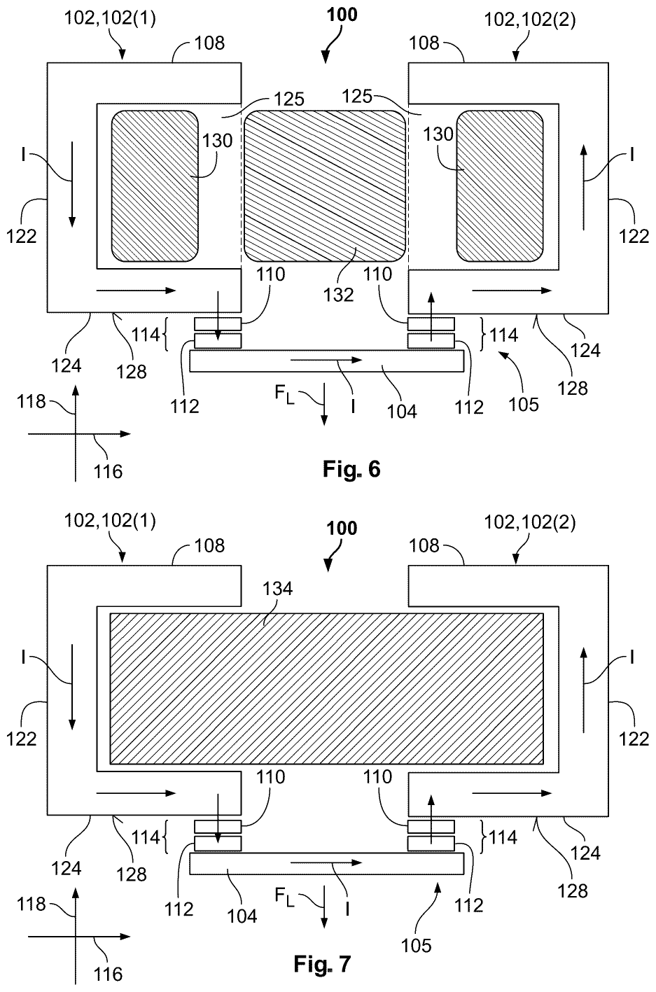

In order to at least partially counteract the repulsion forces acting on the contact bridge 104, the contact arrangement 100 can optionally comprise at least a second ferromagnetic flow guiding piece 132, which is aligned in such a way that it exerts an attractive force on the contact bridge 104 (or more specifically on the operational current I flowing in the contact bridge 104) when the contact bridge 104 is in the closed position 105. As shown schematically in FIG. 6, the second flow guiding piece 132 is arranged along the switching direction 118 above the contact bridge, that is, within a current loop formed by the fixed contacts 102 and the contact bridge 104, so that the contact bridge 104 is pushed in the direction of the fixed contact elements 110 by the attractive force induced by the second flow guiding piece 132. Like the first flow guiding pieces 130, the second flow guiding piece 132 should also be made of a material with a high magnetic permeability, such as iron or an iron alloy, in order to maximize the shielding of the magnetic field B in the direction of the contact bridge 104. The second flow guiding piece 132 can be provided together with the first flow guiding pieces 130 (as in FIG. 6) or as an alternative. As shown schematically in FIG. 7, the first ferromagnetic flow guiding pieces 130 and the second flow guiding piece 132 can also be provided as a single-piece ferromagnetic insert 134, which is arranged between the fixed contacts 102 and which both attenuates the magnetic field B, which is generated by current flow in the first legs 122, in the direction of the contact bridge 104 and exerts an attractive force on the contact bridge 104 (or more specifically on the operational current I flowing in the contact bridge 104).

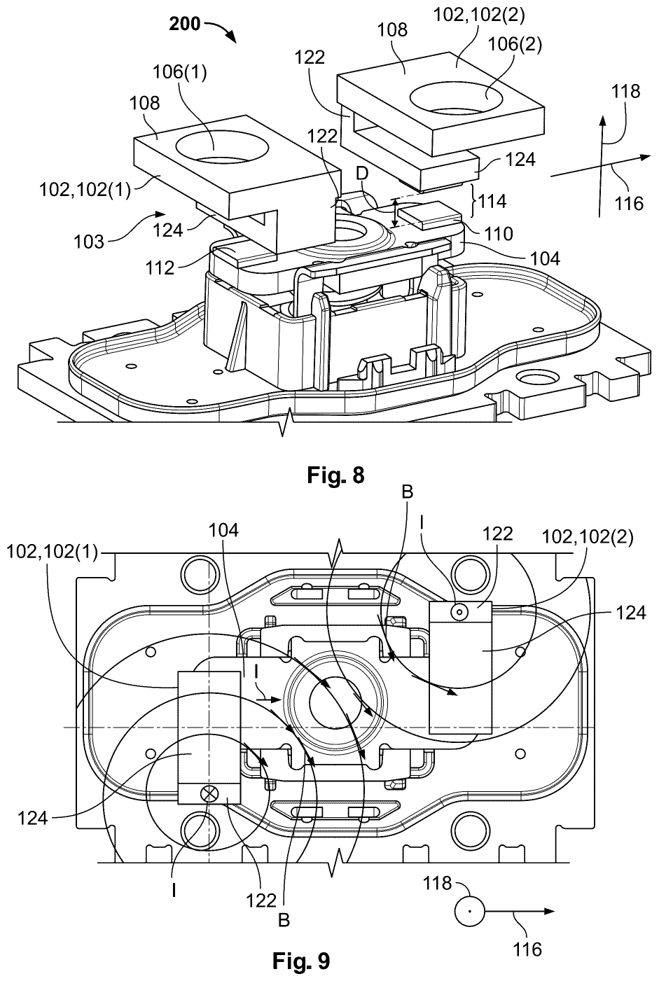

FIGS. 8 and 9 show schematic views of a second exemplary contact arrangement 200. All components of the second exemplary contact arrangement 200, in particular the fixed contacts 102 and the contact bridge 104, are designed as described for the first exemplary contact arrangement 100, however, the two fixed contacts 102(1) and 102(2) are each arranged asymmetrically. In particular, the fixed contacts 102(1) and 102(2) are arranged such that the longitudinal directions of the second legs 124 extend respectively perpendicular to the contact bridge longitudinal direction 116 and the switching direction 118 of the contact bridge 104. In this manner, the distance between the first legs of the two fixed contacts 102(1) and 102(2) and the contact bridge 104 can be increased by the arrangement of the second leg 124, which reduces the repulsion forces acting on the contact bridge 104. An example of the magnetic field B generated by the flow of the operational current I in the first legs 122 of the two fixed contacts 102(1) and 102(2) is shown in FIG. 9, where, for a better illustration, the base 108 of the fixed contacts 102 is not shown in each case.

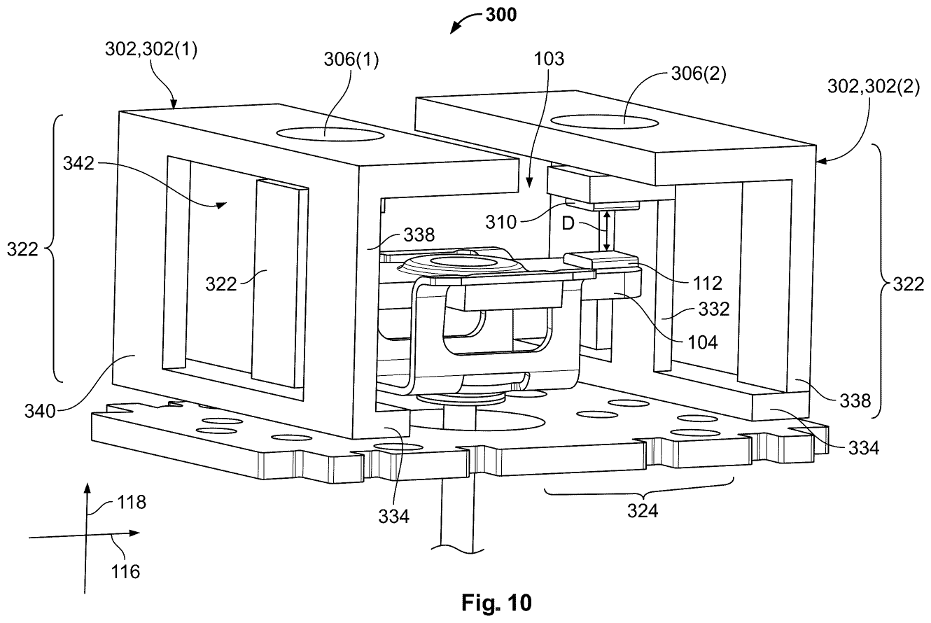

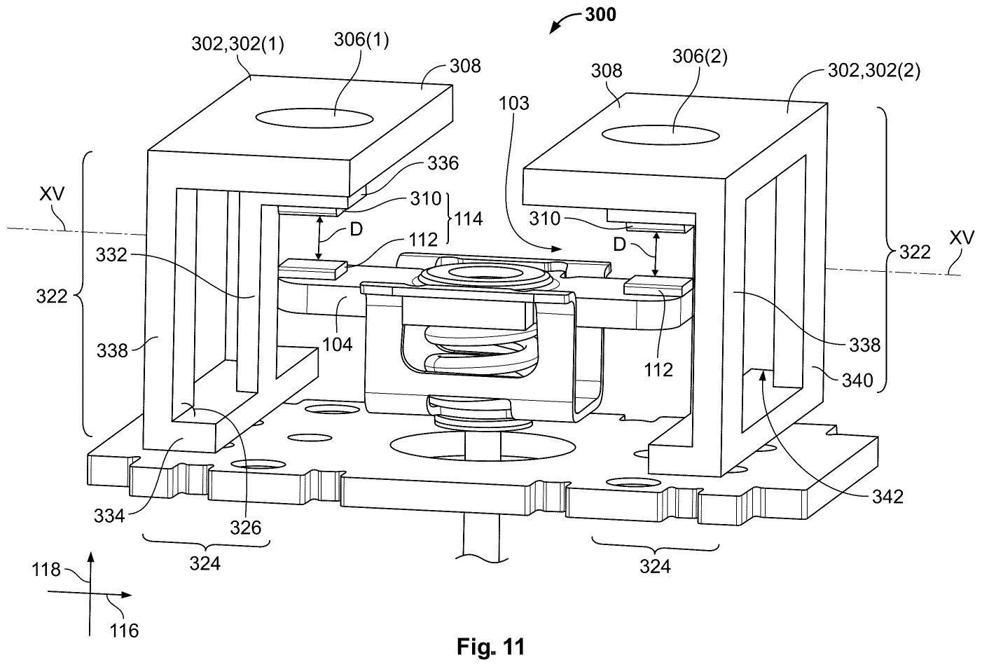

On the basis of FIGS. 10 to 16, a third exemplary contact arrangement 300 is described below, which differs from the first exemplary contact arrangement 100 in the design of the fixed contacts 302(1) and 302(2). The fixed contacts 302(1) and 302(2) are also designed with a first leg 322 and a second leg 324, wherein the second leg 324 serves respectively as a spacer to ensure a certain distance between the first leg 322 of each of the fixed contacts 302 and the contact bridge 104.

As can be seen in the schematic perspective views of FIGS. 10 to 12, each of the second legs 324 of the two fixed contacts 302(1) and 302(2) has an additional leg section 332, which respectively extends parallel to the first legs 322 of the two fixed contacts 302(1) and 302(2). In the leg section 332, in the closed position 105 of the contact bridge 104, an electrical operational current I flowing through the fixed contact 302 generates attractive forces in the contact bridge 104, which press the contact bridge 104 in the direction of the two fixed contacts 302(1) and 302(2). The attractive forces generated by the current flow in the leg section 332 are thus forces that counteract the repulsion forces generated by the current flow in the first leg 322, at least partially compensating for the repulsion forces if not exceeding them.

As described for the first exemplary contact arrangement, the first leg 322 of the fixed contacts 302 also respectively extends downwards from a base 308, which respectively has a connection element 306, parallel to the switching direction 118 of the contact bridge 104. The second leg 324 respectively adjoins the first leg 322. In order to ensure a compact design of the fixed contacts 302, the second leg 324 is advantageously formed in a stepped manner. In particular, the second leg 324 has a connecting section 334, which connects the first leg 322 to the leg section 332 of the second leg 324. Hereby, the connecting section 322 is advantageously aligned parallel to the contact bridge longitudinal direction 116 in order to maximize the distance between the first leg 322 and the leg section 332 of the second leg 324. Furthermore, the second leg comprises a contact projection 336, which protrudes from the leg section 332 along the contact bridge longitudinal direction 116 and on which the fixed contact elements 310 are arranged.

The sections of the second leg 324 described above can be designed respectively to be formed plate-shaped, for example as rectangular bus-bars. The fixed contact elements 310 can, for example, be welded, soldered, pressed or screwed to the contact projection 336.

In order to compensate as much as possible for the repulsion forces acting on the contact bridge 104 due to the current flow in the first leg 322, the leg section 332 of the second leg 324 is arranged parallel to the first leg, wherein the leg section 332 of the second leg 324 is arranged in particular such that a longitudinal direction of the second leg extends perpendicular to the contact bridge longitudinal direction 116. Hereby, the leg section 332 of the second leg 324 is aligned such that a current component of the operational current I along the switching direction 118 in leg section 332 is in the opposite direction to the current component of the operational current I in the first leg. In particular, in the leg section 332 of the second leg 324, a current direction of the operational current I is to run parallel to a closing direction of the contact bridge 104, which points from the open position 103 to the closed position 105.

In order to ensure the compact design of the fixed contacts 302, the connecting section 334 and the contact projection 336 are respectively preferably arranged perpendicular on the leg section 332, and the connecting section 334 thus in particular encloses an opening angle 326 of approximately 90° with a longitudinal direction of the first leg 322. Depending on the application requirements, however, other opening angles can also be selected. Thus, the second leg 324 is arranged on the first leg 322 in such a way that the first leg 322 and the second leg 324 together with the base 308 of the fixed contact 302 form a “G” shape in the side view (see FIG. 13).

The fixed contact elements 310 are each arranged on an outer surface 328 of the fixed contacts 302(1) and 302(2), which is respectively formed by an outer surface of the contact projection 336 of the second leg 324, and which lies on an outer side of a projection volume 325 spanned by the first leg 322 and by the second leg 324 (see FIG. 13). The projection volume 325 spanned by the first leg 322 and the second leg 324 is to be understood as the volume that is located within the fixed contacts 302(1) and 302(2) if it were to be closed by an (imaginary) plate on the open side. In other words, the fixed contact elements 310 are arranged respectively on an outer surface of the contact projections 336 of the second legs 324, which faces away from the base 308 and the associated terminal sections 306. Thus, the contact surfaces of the fixed contact elements 310 point in the direction of the actuation device and the contact bridge 104 can be pressed onto the fixed contact elements 310 from the outside, i.e. from outside the “G” shape spanned by the fixed contacts, in the switching direction 118, in order to electrically connect the two fixed contacts 302(1) and 302(2) to one another. Hereby, the actuation device of the switching element moves the contact bridge 104 between the closed position 105 and the open position 103 respectively outside the projection volume 325 spanned by the first leg 322 and by the second leg 324.

This has the advantage that the contact bridge 104 can be pressed from the outside onto the fixed contacts 302 by the actuation device, thus avoiding the need to install a complicated actuation device. In particular, the contact bridge 104 can be biased against the closing direction by a spring element (not shown) in the open position 103, so that the spring element supports a quick opening of the contact bridge 104 when the bridge is brought from the closed position 105 to the open position 103. Furthermore, the impact on electric arcs by blowout magnets, which are provided in the switching element, is simplified.

The following is an explanation of the functioning of the third exemplary contact arrangement 300 when the contact bridge 104 is in the closed position 105. Here, too, it is assumed that the fixed contact 302(1) is connected to the high-potential side of the circuit (for example to a positive terminal of a drive battery) via the connection element 306, so that the operational current I, as schematically shown in FIG. 13, flows from the fixed contact 302(1) via the contact bridge 104 into the fixed contact 302(2). Due to the specific shape of the fixed contact 302(1), the operational current I flows along (or parallel to) the switching direction 118 of the contact bridge 104 in the first leg 322 of the fixed contact 302(1) in the opposite direction to the closing direction of the contact bridge 104. In contrast, in the leg section 332 of the second leg 324 of the fixed contact 302(1), the operational current I flows along (or parallel to) the switching direction 118 of the contact bridge 104 in the direction of the closing direction of the contact bridge 104. In the fixed contact 302(2), the operational current flows in the individual elements in each case in the opposite direction along the switching direction 118 when compared to the fixed contact 302(1).

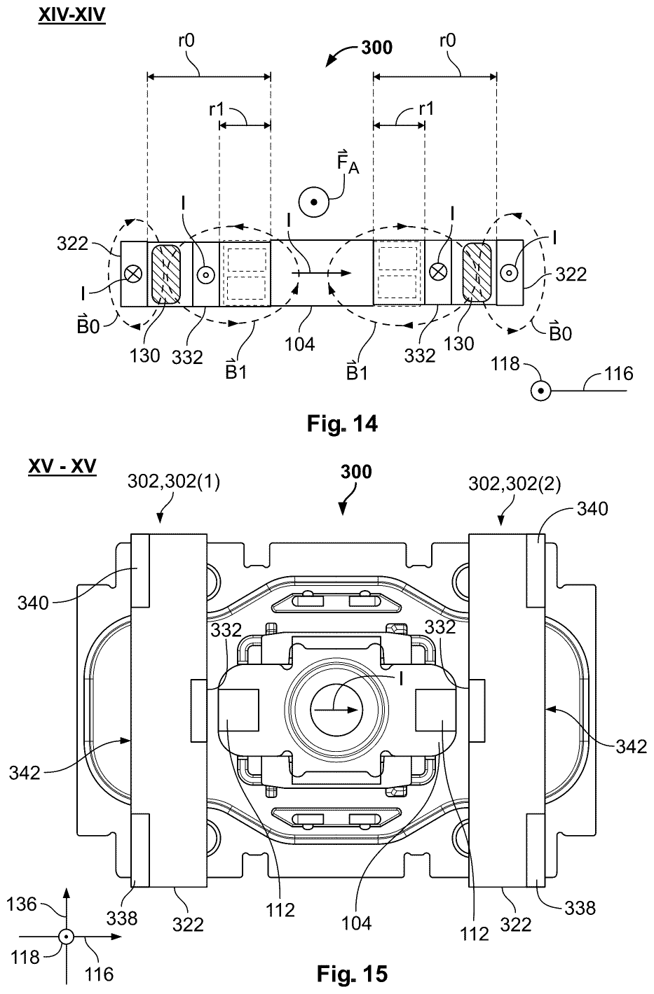

As shown schematically in FIG. 14, a magnetic field B0 is generated by the current flow in the first leg 322 of the two fixed contacts 302(1) and 302(2), which respectively surrounds the first legs 322 of the two fixed contacts 302(1) and 302(2) in a circle. Likewise, the current flow in the leg section 332 of the second leg 324 of the two fixed contacts 302(1) and 302(2) generates a magnetic field B1, which respectively surrounds the leg section 332 of the second leg 324 of the two fixed contacts 302(1) and 302(2) in a circle. Due to their alignment, the magnetic fields B0, which are generated in the first legs 322 of the two fixed contacts 302(1) and 302(2), exert a repulsive Lorentz force on the operational current I flowing in the contact bridge 104, which acts against the closing direction of the contact bridge 104 and pushes the contact bridge 104 in the direction of the open position 103. In contrast, the magnetic fields B1, which are generated in the leg section 332 of the second leg 324 of the two fixed contacts 302(1) and 302(2), are oriented in such a way that they exert an attractive Lorentz force FA (see FIGS. 13 and 14) on the operational current I flowing in the contact bridge 104. The attractive Lorentz force FA acts in the closing direction of the contact bridge and pushes the contact bridge 104 in the direction of the closed position 105.

Thus, an attractive force FA (see FIGS. 13 and 14) is induced by the current flow in the leg sections 332 of the second leg 324 of the two fixed contacts 302(1) and 302(2) on the contact bridge 104, which counteracts the repulsion forces between the fixed contact elements 110 and the switching contact elements 112 in each of the contact pairs 114 when current flows, and which pushes the contact bridge in the direction of the closed position 105. In particular, the attractive force FA also counteracts the repulsion force arising from the current flow in the first legs 322 of the two fixed contacts 302(1) and 302(2). This additional attractive force FA ensures that in the event of a short-circuit at currents of up to 20 kA, unwanted opening of the contact bridge 104 in the contact arrangement 300 is suppressed or at least delayed until an overcurrent protection device in the circuit connected to the contact arrangement 300 is triggered.

Since the magnetic field generated in the fixed contacts 302 is dependent on the distance, a distance r0 between the first leg and the contact bridge 104 along the contact bridge longitudinal direction 116 should advantageously be greater, respectively, than a distance r1 between the leg section 332 of the second leg 324 and the contact bridge 104 along the contact bridge longitudinal direction 116. Thus, the attractive force FA induced by the current flow in the fixed contacts 302 in the contact bridge 104 can be maximized in comparison to the repulsion force induced by the current flow in the fixed contacts 302 in the contact bridge 104. The ratio of the distance r0 to the distance r1 can be defined by the length of the connecting element 334. Hereby, the distances r0 and r1 (see FIG. 13) may be chosen such that the repulsion forces acting on the contact bridge 104 are compensated sufficiently strongly by the attractive forces FA to delay an opening of the contact arrangement 300, while at the same time certain distances should nevertheless not be exceeded in order to prevent the space requirement of the contact arrangement 300 from becoming too large. In order to achieve common installation space sizes, for example, r1 can be selected in the range of approximately 4 mm to 8 mm, while r0 is selected in the range of approximately 15 mm to 20 mm.

In order to further maximize the attractive forces FA, a length L (see FIG. 13) of the contact bridge 104 along the contact bridge longitudinal direction 116 between the closing contact elements 112 can be selected to be as long as possible, in order to increase the penetration area, in which the magnetic field B1 generated in the leg section 332 of the second leg 324 of the fixed contacts 302 by the current flow penetrates the contact bridge 104.

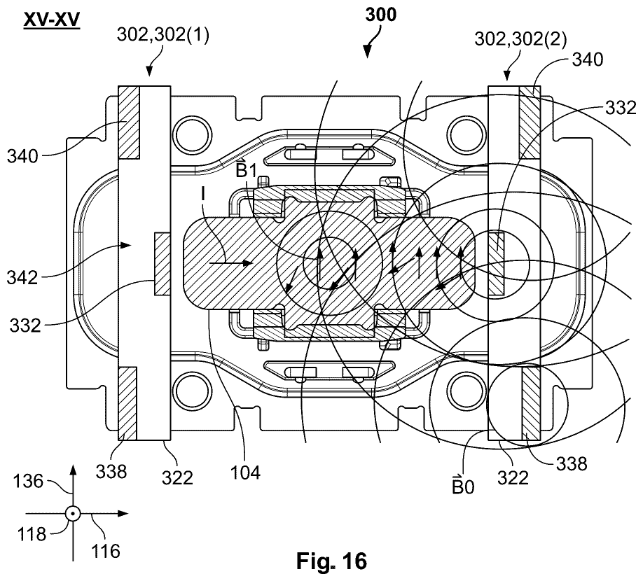

The distance between the first legs 322 of the fixed contacts 302 and the contact bridge 104 can be further increased by the fixed contacts having at least a first current conducting element 338 and a second current conducting element 340, which are separated from each other by means of an air gap 342, so that the first current conducting element 338 and the second current conducting element 340 are offset in a contact bridge transverse direction 136 (see FIG. 15 and FIG. 16) with respect to each other and with respect to the contact bridge 104. By way of illustration, FIG. 16 shows a schematic representation of the resulting magnetic field B0, which is generated when current flows in the first current conducting element 338 of the first leg 322 of the fixed contact 302(2), and the magnetic field B1 that is generated when current flows in the leg section 332 of the second leg 324 of the fixed contact 302(2).

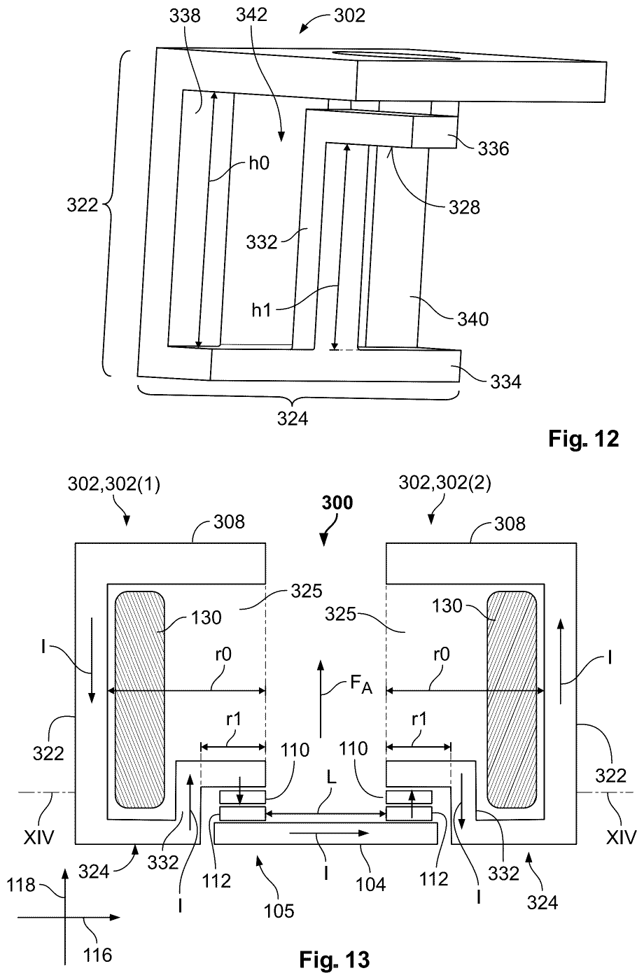

Since the magnetic field generated in the at least one leg section 332 of the second leg 324 scales with a length h1 (see FIG. 12) of the at least one leg section 332 between the connecting section 334 and the contact projection 336, the length h1 of the at least one leg section 332 may be at least half as long as a length h0 of the first leg 322 between the connecting section 334 of the second leg 324 and the base 308. Depending on the size of the distances r0 and r1, the length h1 of the at least one leg section 332 of the second leg 324 can also be chosen to be longer in comparison to the length h0 of the first leg 322 and h1 can, for example, be between 70% and 90% of h0.

In order to further attenuate the magnetic field B0 generated in the first legs 322 of the fixed contacts 302 by the current flow, the contact arrangement 300 can have first flow guiding pieces 130, as shown schematically in FIGS. 13 and 14. In this case, the first flow guiding pieces 130 may completely surround the first legs 322 of the two fixed contacts 302(1) and 302(2). In order to save material, the first flow guiding pieces 130 may only surround the first legs 322 of the two fixed contacts 302(1) and 302(2) respectively in the direction of the contact bridge 104, in order to attenuate the magnetic field B, which is generated by the current flow in the first legs 322, in the direction of the contact bridge 304. The first flow guiding pieces 130 should be made of a material with a high magnetic permeability, such as iron or an iron alloy, in order to maximize the shielding of the magnetic field B in the direction of the contact bridge 104. In order to at least partially counteract the repulsion forces acting on the contact bridge 104, the contact arrangement 300 can optionally comprise at least a second ferromagnetic flow guiding piece 132, which is aligned in such a way that it exerts an attractive force on the contact bridge 104 (or more specifically on the operational current I flowing in the contact bridge 104) when the contact bridge 104 is in the closed position 105. Alternatively, a single-piece ferromagnetic insert 134 can also be arranged in the contact arrangement 300 between the two fixed contacts 302(1) and 302(2), wherein the ferromagnetic insert 134 is aligned to both attenuate the magnetic field B, generated by current flow in the first legs 322, in the direction of the contact bridge 104 and to exert an attractive force on the contact bridge 104.

In the examples shown above, the movement of the contact bridge 104 can be stabilized respectively by a support structure 150 of the contact arrangement, wherein the contact bridge 104 is held movable in the support structure 150. In particular, the contact bridge 104 can be attached by means of the support structure 150 to a shaft 152, which transfers the force generated by the actuation device to the contact bridge 104. The support structure 150 of the examples shown so far can optionally have an over-stroke spring 154, with which the contact bridge 104 is prestressed in the direction of the closed position 105. The compression of the over-stroke spring 154 generates the contact force and in turn makes it possible to compensate for differences in position, manufacturing tolerances and operational wear between the contact pairs 114 at different ends of the contact bridge 104.

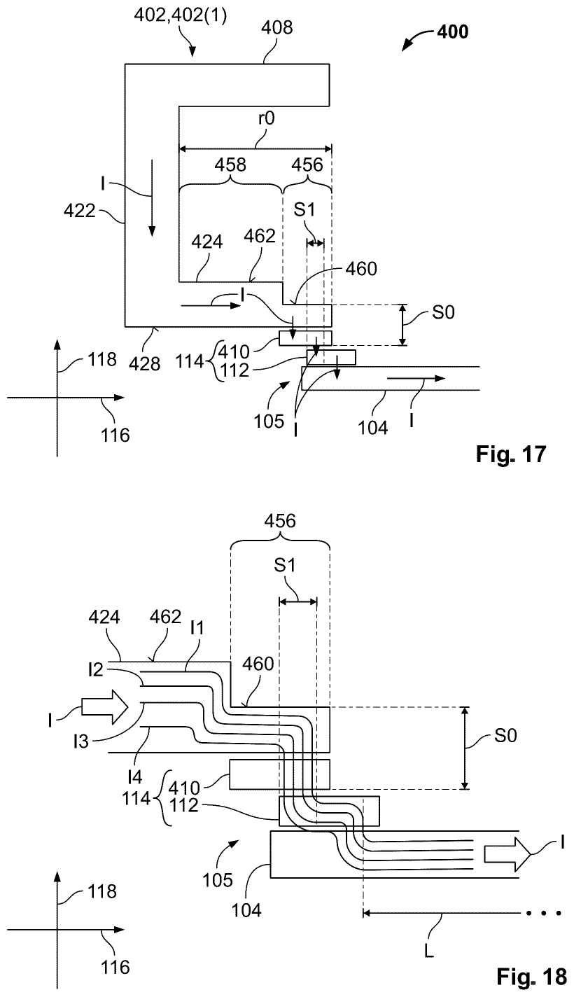

FIGS. 17 and 18 show sections of schematic side views of a fourth exemplary contact arrangement 400. Here, only one of the two fixed contacts 402 is respectively shown, in this case fixed contact 402(1). FIG. 18 shows a magnification of the contact area between the fixed contact 402 and the contact bridge 104 of FIG. 17. The fourth exemplary contact arrangement 400 differs from the exemplary contact arrangements 100, 200 and 300 shown above in that that, in addition to the specific shape of the fixed contacts, a thickness reduction of the fixed contacts (along the switching direction 118) is provided in a contact area 456, when compared to a connecting area 458, which adjoins the contact area 456. As described below, this thickness reduction of the contact area 456 also contributes in reducing the repulsion forces acting on the contact bridge 104. Thus, the configurations of the contact area 456 (and the connecting area 458) described below may also be provided in each of the second legs 124 and 324 of the exemplary contact arrangements 100, 200 and 300. However, the configurations described below can also be used for fixed contacts with shapes other than those described so far.

In the example shown in FIGS. 17 and 18, the fixed contact 402 of the fourth exemplary contact arrangement 400 has the same basic structure as the fixed contact 102 of the first exemplary contact arrangement 100. The base 408, the first leg 422 and the second leg 424 of the fixed contact 402 are arranged so that the fixed contact 402 has a “C” shape when viewed in a side view. In addition, the second leg 424 has a contact section 456, in which the fixed contact elements 410 are mounted, and a connecting section 458, which adjoins the contact section 456 and connects the contact section 456 to the first leg 422. As shown in FIGS. 17 and 18, the contact section 456 is designed to be thinner in the switching direction 118 than the connecting section 458. Thus, the contact section 456 protrudes as a protrusion from the thicker part of the second leg 424, which is formed by the connecting section 458. In this case, a top side 460 of the contact section 456 is offset downwards with respect to a top side 462 of the connecting section 458 in the switching direction 118.

As schematically shown by the current paths I1, I2, I3 and I4 in FIG. 18, the lowering of the top side 460 of the contact section 456 can control the current flow of the operational current I through the contact pairs 114 in such a way that a current, which flows perpendicular to the contact bridge longitudinal direction 116 in the contact section 456, and thus in the immediate vicinity of the contact bridge 104, can be limited to a maximum length s0 (in direction 118). In this manner, the magnetic field strength of a magnetic field caused by the current flow in the contact section 456 can be attenuated, so that the repulsion forces on the contact bridge 104, which are generated by the Lorentz force of such a magnetic field, are also attenuated.

As shown schematically in FIGS. 17 and 18, in addition to the special shape of the contact area 456 in each contact pair 114 of the contact arrangement 400, the fixed contact element 410 and the associated switching contact element 112 can be arranged offset with respect to one another along the contact bridge longitudinal direction 116 (which extends parallel to the arrangement direction of the fixed contacts 402). This means that in the closed position 105, the contact surfaces of the fixed contacts 402 and the contact bridge 104 are each formed only by a partial area of the fixed contact elements 410 and the associated switching contact elements 112, so that a current flow between the contact elements takes place only in this partial area. Hereby, the switching contact elements 112 are offset with respect to the associated fixed contact elements 410 in the direction of the center of the contact bridge 104, so that the contact surfaces are formed respectively by the outer sub-region of the fixed contact elements 410 and the associated switching contact elements 112, which are closer to the end face of the second leg 424 or the contact bridge 104.

As schematically represented by the current paths I1, I2, I3 and I4 in FIG. 18, the offset of the contact elements in the contact pairs 114 may be used to control the flow of the operational current I through the contact pairs 114 in such a manner that a current flowing from the fixed contact element 410 into the associated switching contact element 112 (or vice versa) perpendicular to the contact bridge longitudinal direction 116 can be limited to a maximum length s1 (in direction 116). In this way, the magnetic field strength of a magnetic field that arises due to the current flow through the fixed contact elements 410 and the switching contact elements 112 (parallel to the switching direction 118) can be reduced. Since such a magnetic field also generates repulsive forces in the contact bridge 104 due to the Lorentz force (similar to the currents in the first legs 122, 322, 422 of the fixed contacts 102, 302, 402) the repulsion forces acting on the contact bridge 104 in the closed position 105 can also be attenuated by the offset of the associated fixed contact elements 410 and switching contact elements 122 with respect to one another. Optionally, the offset of the contact elements in the contact pairs 114 can also be provided in the first exemplary contact arrangement 100 and in the third exemplary contact arrangement 300.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A contact arrangement for an electrical switching device, the contact arrangement comprising:
two fixed contacts that are spaced apart from each other along an arrangement direction, and
an electrically conductive contact bridge that is movable along a switching direction and has electrically conductive switching contact elements for establishing contact with each of the two fixed contacts,
wherein the contact arrangement has at least a closed position and an open position), wherein, in the closed position, the switching contact elements of the contact bridge establish electrical contact with the respectively associated fixed contacts, and, in the open position, the switching contact elements of the contact bridge have a predefined contact distance, measured in the switching direction, to the respectively associated fixed contacts,
wherein the two fixed contacts respectively comprise at least a first leg and a second leg,
wherein the two fixed contacts are respectively contactable by at least one of the switching contact elements of the contact bridge on an outer surface of the second leg, which is arranged on an outer side of a projection volume spanned by the first leg and by the second leg, are electrically.

2. The contact arrangement according to claim 1, wherein in the open position, the contact bridge is located outside the projection volume spanned by the first leg and by the second leg.

3. The contact arrangement according to claim 1, wherein each of the two fixed contacts has at least one fixed contact element forming a contact pair with a respectively associated switching contact element of the contact bridge, and wherein the at least one fixed contact element is located respectively at an end of the second leg which is located opposite the first leg, and
preferably wherein, in each of the contact pairs, the fixed contact element and the associated switching contact element are arranged offset with respect to one another at least along the arrangement direction.

4. The contact arrangement according to claim 1, wherein the second leg is respectively aligned parallel to a contact bridge longitudinal direction of the contact bridge), which extends parallel to the arrangement direction.

5. The contact arrangement according to claim 1, wherein the first leg is respectively aligned parallel to the switching direction of the contact bridge.

6. The contact arrangement according to claim 1, wherein the first leg and the second leg are respectively plate-shaped, and wherein the second leg is arranged on the first leg at a predefined opening angle, preferably perpendicularly.

7. The contact arrangement according to claim 1, wherein the second leg has at least one leg section in which an electric current flowing through the second leg generates attractive forces in the contact bridge which push the contact bridge towards the two fixed contacts.

8. The contact arrangement according to claim 7, wherein the second leg is designed in a stepped manner.

9. The contact arrangement according to claim 7, wherein in each of the two fixed contacts the at least one leg section of the second leg is arranged parallel to the first leg, and
wherein an electric current, which flows through the at least one leg section parallel to the switching direction in the closed position, flows in the opposite direction to an electric current, which flows through the first leg parallel to the switching direction in the closed position.

10. The contact arrangement according to claim 7, wherein in each of the two fixed contacts a distance between the first leg and the contact bridge is greater than a distance between the at least one leg section of the second leg and the contact bridge.

11. The contact arrangement according to claim 7, wherein in each of the two fixed contacts a length of the at least one leg section of the second leg along the switching direction is at least half as large as a length of the first leg along the switching direction.

12. The contact arrangement according to claim 6, wherein in each of the two fixed contacts the first leg has at least two current conducting elements respectively, which are separated from each other by an air gap and which are electrically connected to the second leg separately from one another.

13. The contact arrangement according to claim 1, wherein the first leg of each of the two fixed contacts is respectively at least partially surrounded by a flow guiding piece which at least partially shields a magnetic field generated in the first leg by current flow in the direction of the contact bridge; and/or
wherein the contact arrangement has at least one ferromagnetic flow guiding which, at least in the closed position, exerts an attractive force on the contact bridge.

14. The contact arrangement according to claim 1, wherein in each of the second legs a contact section, in which the associated switching contact elements of the contact bridge establish electrical contact with the second leg, is thinner than a connecting section, which connects the contact section to the associated first leg, wherein the thickness of the contact section and of the connecting section is measured respectively parallel to the switching direction.

15. An electrical switching device, comprising the contact arrangement according to claim 1 and an actuation device, which is designed to move the contact bridge of the contact arrangement between the closed position and the open position.

16. A contact arrangement for an electrical switching device, wherein the contact arrangement comprises:
two fixed contacts that are spaced apart from each other along an arrangement direction, and
an electrically conductive contact bridge that is movable along a switching direction and has electrically conductive switching contact elements for establishing contact with each of the two fixed contacts,
wherein the contact arrangement has at least a closed position and an open position, wherein, in the closed position, the switching contact elements of the contact bridge establish electrical contact with the respectively associated fixed contacts, and, in the open position, the switching contact elements of the contact bridge have a predefined contact distance, measured in the switching direction, to the respectively associated fixed contacts,
wherein in each of the fixed contacts a contact section, in which the switching contact elements of the contact bridge establish electrical contact with the respectively associated fixed contact, is thinner than a section of the fixed contact that is adjacent to the contact section, wherein the thickness of the contact section and of the adjacent section is measured respectively parallel to the switching direction.

17. The contact arrangement according to claim 16, wherein each of the two fixed contacts has at least one fixed contact element forming a contact pair with a respectively associated switching contact element of the contact bridge, and wherein, in each of the contact pairs, the fixed contact element and the associated switching contact element are arranged offset with respect to one another at least along the arrangement direction.
